(19) United States
(12) Patent Application Publication
(10) Pub. No.: US 2005/0155517 A1
(43) Pub. Date: Jul. 21, 2005

(54) Watercolor ink composition for writing utensils and method for producing it

(76) Inventor: Tatsumi Uchida, Tokyo (JP)

Correspondence Address: Edwards & Angell, LLP, P.O. Box 55874, Boston, MA, 02205, US

(21) Appl. No.: 11/023,936

(22) Filed: Dec. 28, 2004

(30) Foreign Application Priority Data
Jan. 15, 2004 (JP) 2004-008318

(51) Int. Cl. C09D 1/00

(52) U.S. Cl. 106/31.95

(57) ABSTRACT

A watercolor ink composition for writing utensils comprising at least an alkali-soluble acrylic copolymer, a lower alcohol solvent, water, and a coloring material wherein the alkali-soluble acrylic copolymer has a molecular weight of from 7000 to 15,000, an acid value of from 30 to 100, and a glass transition point of from −10 to 60° C. The watercolor ink composition for writing utensils that has colored or colorless transparency in appearance and has both transparent feeling and solid feeling in handwriting can be provided.

### FIELD OF THE INVENTION

The present invention relates to a watercolor ink composition for writing utensils having colored or colorless transparency in appearance and particularly to a watercolor ink composition for writing utensils having both transparent feeling and solid feeling in handwriting drawn by use of the ink compositions. The invention further relates to a method for producing such watercolor ink composition for writing utensils.

### DESCRIPTION OF THE RELATED ART

In the field of posters, illustrations, or ornaments, handwriting having a feeling of building up wherein the handwriting is swollen out has hitherto been expected in some cases, and various ink compositions have been proposed in order to realize such handwriting. For example, JP-A-3-290473 discloses paints for building up characterized by mixing clay acting as a main component in order to build up, clay which is dissolved in water and allowed to stand for a prescribed period of time, an acrylic paint for staining that is dissolved in ethyl alcohol, a bonding material to heighten conformability and adhesion between base and paint, and slip comprising fine particles for surface finish. JP-A-6-220382 discloses emulsion inks for stencil printing characterized in that in a water-in-oil type emulsion comprising an oil phase and a water phase, an oil-in-water type resin emulsion is used as the above water phase. And the patent literature describes that characters printed by use of the emulsion ink for stencil printing have the feeling of building up. Furthermore, JP-A-2002-285066 discloses paint ink compositions characterized by use of paraffin as a binder and describes that thick coating with the paint ink enables solid expression and ornament having a solid feeling.

However, these ink compositions lack transparency, and watercolor ink compositions for writing utensils that have colored or colorless transparency in appearance and leave handwriting having both transparent feeling and solid feeling have not been realized yet.

### SUMMARY OF THE INVENTION

An object of the present invention is to provide an improved watercolor ink composition for writing utensils. In particular it is an object of the present invention is to provide a watercolor ink composition for writing utensils that has colored or colorless transparency in appearance and have both transparent feeling and solid feeling in handwriting.

These and other objects are obtained in accordance with one aspect of the invention by a watercolor ink composition for writing utensils comprising at least an alkali-soluble acrylic copolymer, a lower alcohol solvent, water, and a coloring material wherein the alkali-soluble acrylic copolymer has a molecular weight of from 7000 to 15,000, an acid value of from 30 to 100, and a glass transition point of from −10 to 60° C.

The present inventors have intensively studied in order find a solution of the above-described problems and as a result thereof found that when watercolor ink compositions for writing utensils comprise at least an alkali-soluble acrylic copolymer, a lower alcohol solvent, water, and a coloring material wherein the alkali-soluble acrylic copolymer has a molecular weight of from 7000 to 15,000, an acid value of from 30 to 100, and a glass transition point of from −10 to 60° C., the watercolor ink compositions have colored or colorless transparency in appearance and have both transparent feeling and solid feeling in handwriting.

It is preferred that the amount of the alkali-soluble acrylic copolymer contained in the total amount of ink is from 20 to 55 weight percent. Moreover the water preferably accounts for 20 weight percent or more and 80 weight percent or less of the total amount of ink solvents and the water-soluble lower alcohol solvent accounts for the residual amount.

In accordance with another aspect of the invention a method of producing a watercolor ink composition for writing utensils is provided, which includes the step of stirring at least an alkali-soluble acrylic copolymer having a molecular weight of between 7000 and 15,000, an acid value between 30 and 100, and a glass transition point of between −10° and 60° C., a lower alcohol solvent, water, and a coloring material, at a temperature between room temperature and about 60°, preferably between room temperature and about 50°.

### DETAILED DESCRIPTION OF THE INVENTION

The invention will now be described in more details hereinafter.

The alkali-soluble acrylic copolymers used in the invention are copolymers that are prepared by copolymerizing appropriately acrylic esters, styrene, acrylic acid, maleic acid, methacrylic acid, or the like, have acidic groups such as carboxyl group in molecule, and are dissolved in water in the coexistence with alkaline substances. In the invention, the alkali-soluble acrylic copolymers having molecular weights of from 7000 to 15,000, acid values of from 30 to 100, and glass transition points of from −10 to 60° C. are added and used in a ratio of from 20 to 55 weight percent. Examples of such copolymers include acrylic acid-methacrylic ester copolymers, polyacrylic ester copolymers, acrylic acid-styrene copolymers, maleic acid-styrene copolymer, and the like and these copolymers can be used singly or as mixtures of two or more thereof. The molecular weights less than 7000 lead to too low viscosity to make it difficult to obtain solid writing lines and moreover to fix handwriting itself. Exceeding 15,000 results in increasing remarkably the viscosity of ink even by addition of a small amount of the copolymers, making it difficult to add a sufficient amount thereof and to obtain a sufficient solid feeling, and moreover causing deterioration in fluidity.

The alkali-soluble acrylic copolymers used in the invention have acid values of from 30 to 100. The acid values less than 30 make it difficult to dissolve in ink solvent to cause turbidity and mar the transparent feeling. Exceeding 100 leads to deterioration in resistance to water and causes remarkable stringing on writing.

Furthermore, the alkali-soluble acrylic copolymers used in the invention have glass transition points of from −10 to 60° C. The glass transition point less than −10° C. causes stickiness in handwriting after drying, and exceeding 60° C. results in causing cracking in handwriting after drying.

The amount of the above-described alkali-soluble acrylic copolymers to be used in the total amount of ink is from 20 to 55 weight percent. The amount less than 20 weight percent results in too insufficient amount of resin components left after drying handwriting for drawing solid lines. Exceeding 55 weight percent causes remarkable increase in the viscosity of ink, leading to deterioration in fluidity. Although one or two or more of lower amines that form gases at 20° C., that is, ammonia, monomethylamine, monoethylamine, dimethylamine, and trimethylamine, are used as the alkaline substances to solubilize the resins, ammonia is desirable in view of quick drying. The alkaline substances are desirably added so as to adjust to pH 7 to 10 to dissolve the resins.

The solvents used in the invention are mixtures of water and lower alcohol solvents, and the ratio of water to the total ink solvent is from 20 to 80 weight percent. The amount less than 20 weight percent promotes penetration of the ink into paper, though depending upon the kind of paper, to make it difficult to draw solid lines. Exceeding 80 weight percent makes dissolution of the resins difficult though depending upon the acid value. Examples of the alcoholic solvents include ethanol, isopropyl alcohol, n-propyl alcohol, propylene glycol monomethyl ether, and the like. These solvents can be used singly or mixtures of two or more thereof.

As coloring materials used in the invention, dyes or pigments for ordinary alcohol-series and water-series inks can be used for staining to an extent that appearance of the ink loses no transparency, and specific examples thereof include water- and alcohol-soluble ones, direct dyes such as C.I. Direct Yellow 44, C.I. Direct Yellow 50, C.I. Direct Red 84, C.I. Direct Red 225, C.I. Direct Violet 9, C.I. Direct Blue 2, and C.I. Direct Green 30, basic dyes such as C.I. Basic Yellow 25, C.I. Basic Orange 2, C.I. Basic Red 9, C.I. Basic Violet 3, C.I. Basic Blue 1, and C.I. Basic Blue 9, acid dyes such as C.I. Acid Yellow 1, C.I. Acid Yellow 7, C.I. Acid Orange 7, C.I. Acid Red 1, C.I. Acid Red 13, C.I. Acid Red 87, C.I. Acid Violet 7, C.I. Acid Blue 7, C.I. Acid Blue 9, C.I. Acid Blue 74, C.I. Acid Blue 90, C.I. Acid Green 7, C.I. Acid Green 16, and C.I. Acid Brown 39, or alcohol-soluble dyes, C.I. Solvent Black 5, C.I. Solvent Black 7, C.I. Solvent Blue 5, C.I. Solvent Blue 12, C.I. Solvent Blue 25, C.I. Solvent Blue 38, C.I. Solvent Blue 70, C.I. Solvent Red 1, C.I. Solvent Red 8, C.I. Solvent Red 23, C.I. Solvent Red 82, C.I. Solvent Yellow 6, C.I. Solvent Yellow 21, C.I. Solvent Yellow 56, C.I. Solvent Yellow 61, C.I. Solvent Orange 45, C.I. Solvent Violet 21, C.I. Solvent Green 3, and C.I. Solvent Brown 20, and dyes such as fluorescent dyes which are used singly or as mixtures of one or two or more thereof. Moreover, inorganic pigments such as carbon black and titanium dioxide that is a white pigment, organic pigments, fluorescent pigments, and light-storing pigments such as phthalocyanine blue, (C.I. 74160), phthalocyanine green (C.I. 74260), disazo yellow GR (C.I. 21100), permanent red 4R (C.I. 12335), and brilliant carmine 6B (C.I. 15850) can be used singly or as mixtures of two or more thereof.

Moreover, in addition to the above-described components, known additives used for watercolor ink compositions for writing utensils can be used as needed for the ink compositions of the invention, and examples thereof include dispersants, thickeners, wetting agents, high-boiling organic solvents, preservatives, rust preventives, and the like.

In the invention, the above-described ink compositions are mixed and stirred with a known agitator at temperatures of from room temperatures to about 50 or about 60° C. to prepare watercolor inks for writing utensils. The resulting watercolor inks for writing utensils are colorless or transparent and handwriting drawn by use of the inks has both transparent feeling and solid feeling. The transparent feeling of handwriting means that the film formed has no haze to transmit light, and more specifically that colors of paper which handwriting is written on or characters beforehand written are visible through handwriting drawn with the present writing utensils. And the solid feeling means the condition where the film of handwriting portions swells out after drying.

### EXAMPLES

The present invention is more specifically illustrated through examples and comparative examples. The invention is not to be construed as limited by the examples. Parts mean weight parts and wt-% means weight percent.

### Example 1

A watercolor ink composition comprising 99.9 wt-% of water-alcohol solution of acrylic acid-methacrylate ester copolymer and 0.1 wt % of C.I. Solvent Blue 38 was manufactured.

The water-alcohol solution of acrylic acid-methacrylate ester copolymer had the following composition.

| | |
|---|---|
| Acrylic acid-methacrylate ester copolymer | 48.1 parts |
| (Molecular weight 10,900, Acid value 59.5, Tg 20.0° C.) | |
| Ethanol | 32.3 parts |
| Isopropyl alcohol | 1.9 parts |
| n-Propyl alcohol | 2.6 parts |
| Ion-exchanged water | 13.0 parts |
| Aqueous ammonia (28 wt %) | 2.0 parts |

### Example 2

A watercolor ink composition having the following composition was manufactured.

| | |
|---|---|
| Aqueous solution of polyacrylate ester copolymer | 74.6 wt-% |
| (Molecular weight 13,900, Acid value 76.5, Tg −7.5° C.) | |
| Ethanol | 20.3 wt-% |
| Propylene glycol monomethyl ether | 4.9 wt-% |
| C.I. Acid Blue 90 | 0.2 wt-% |

The aqueous solution of polyacrylate ester copolymer had the following composition

| | |
|---|---|
| Polyacrylate ester copolymer | 35.8 parts |
| Ion-exchanged water | 36.0 parts |
| Aqueous ammonia (28 wt %) | 2.8 parts |

### Comparative Example 1

The amount of the aqueous solution of polyacrylate ester copolymer used in Example 2 was decreased to half amount herein and the decreased amount was supplemented with the same amount of ion-exchanged water.

### Example 3

A watercolor ink composition having the following composition was manufactured.

| | |
|---|---|
| Acrylic acid-styrene copolymer | 30.0 wt-% |
| (Molecular weight 8500, Acid value 73.0, Tg 40.0° C.) | |
| Ethanol | 10.0 wt-% |
| Isopropyl alcohol | 5.9 wt-% |
| Ion-exchanged water | 52.0 wt-% |
| Monomethylamine | 1.9 wt-% |
| C.I. Acid Red 87 | 0.2 wt-% |

### Comparative Example 2

The ion-exchanged water used in Example 3 was decreased to 10.0 wt % herein and the decreased amount was supplemented with the same amount of isopropyl alcohol.

### Comparative Example 3

The amount of the resin in Example 3 was doubled herein and the increased amount was decreased in amount of ion-exchanged water.

### Comparative Example 4

A watercolor ink composition having the following composition was manufactured.

| | |
|---|---|
| Acrylic acid-styrene copolymer | 34.0 wt-% |
| (Molecular weight 8500, Acid value 200.0, Tg 85.0° C.) | |
| Ethanol | 8.0 wt % |
| Isopropyl alcohol | 5.9 wt-% |
| Ion-exchanged water | 47.2 wt-% |
| Aqueous ammonia (28 wt %) | 4.8 wt-% |
| Fluorescent pigment | 0.1 wt-% |

### Comparative Example 5

| | |
|---|---|
| Alcoholic solution of acrylic acid-methacrylate | 99.9 wt-% |
| ester copolymer | |
| (Molecular weight 52,200, Acid value 78.8, Tg 1.7° C.) | |
| C.I. Solvent Blue 38 | 0.1 wt-% |

The alcoholic solution of acrylic acid-methacrylate ester copolymer had the following composition.

| | |
|---|---|
| Acrylic acid-methacrylate ester copolymer | 48.1 parts |
| Ethanol | 47.3 parts |
| Isopropyl alcohol | 1.9 parts |
| n-Propyl alcohol | 2.6 parts |

### Comparative Example 6

The aqueous solution of polyacrylate ester copolymer (Molecular weight 13,900, Acid value 76.5, Tg −7.5° C.) in Example 2 was replaced by an emulsion (Ratio of resin to emulsion 45.5 wt-%) of polyacrylate ester copolymer (Molecular weight 24,000, Acid value 19.0, and Tg −15.0° C.).

### Comparative Example 7

The acrylic acid-styrene copolymer (Molecular weight 8500, Acid value 73.0, Tg 40.0° C.) in Example 3 was replaced by an acrylic acid-styrene copolymer (Molecular weight 4600, Acid value 108.0, Tg 60.0° C.).

In Examples 1 to 3 and Comparative Examples 1 to 7, the amounts of the respective components were measured and the components were stirred with a known agitator at temperatures of from 50° C. to 60° C. for about two hours and dissolved.

Qualities of the resulting products were measured according to the following methods. Results are shown in Table 1.

(1) Transparency of ink: The respective inks were put in a transparent glass bottle and the transparency of appearance was graded with ◯ or x by inspection with the naked eye.

(2) Transparent feeling and solid feeling of handwriting: Inks prepared in Examples 1 to 3 and Comparative Examples 1 to 7 were put in extremely narrow corrective pen vessels of this company to obtain writing utensils. Glass plates underwent spiral writing by handwriting with the writing utensils obtained, and the transparency of handwriting, that is, the presence or absence of hazes, and the solid feeling were graded with ◯ or x by inspection with the naked eye.

TABLE 1

| | | Transparent | |
|---|---|---|---|
| | Transparency of | Feeling | Solid Feeling of |
| | Ink | of Handwriting | Handwriting |
| Example 1 | ∘ | ∘ | ∘ |
| Example 2 | ∘ | ∘ | ∘ |
| Example 3 | ∘ | ∘ | ∘ |
| Comparative | ∘ | ∘ | x |
| Example 1 | | | |
| Comparative | ∘ | ∘ | x |
| Example 2 | | | |
| Comparative | Because of marked increase in viscosity preparation of | | |
| Example 3 | inks was Impossible | | |
| Comparative | ∘ | x | x Cracking occurred |
| Example 4 | | | on handwriting |
| | | | after drying |
| Comparative | ∘ | Because of high viscosity of ink, | |
| Example 5 | | handwriting was impossible | |
| Comparative | x | x | ∘ |
| Example 6 | | | |
| Comparative | ∘ | ∘ | x |
| Example 7 | | | |

Results as shown in Table 1 reveal that in the watercolor ink compositions for writing utensils comprising at least an alkali-soluble acrylic copolymer, a lower alcohol solvent, water, and a coloring material wherein the alkali-soluble acrylic copolymer has a molecular weight of from 7000 to 15,000 an acid value of from 30 to 100, and a glass transition point of from −10 to 60° C., the appearance of the ink compositions has colored or colorless transparency and the handwriting thereof has both transparent feeling and solid feeling.

From the disclosure given, those skilled in the art will not only understand the present invention and the attendant advantages, but will also find apparent various changes and modifications to the compositions and examples disclosed. It is sought, therefore, to cover all such changes and modifications as within the spirit and scope of the invention, as defined by the appended claims, and equivalents thereof.

1. A watercolor ink composition for writing utensils comprising at least an alkali-soluble acrylic copolymer, a lower alcohol solvent, water, and a coloring material wherein the alkali-soluble acrylic copolymer has a molecular weight of from 7000 to 15,000, an acid value of from 30 to 100, and a glass transition point of from −10 to 60° C.

2. The composition as described in claim 1, wherein the amount of the alkali-soluble acrylic copolymer contained in the total amount of ink is from 20 to 55 weight percent.

3. The composition as described in claim 1, wherein water accounts for 20 weight percent or more and 80 weight percent or less of the total amount of ink solvents and a water-soluble lower alcohol solvent accounts for the residual amount.

4. A method of producing a watercolor ink composition for writing utensils including the step of stirring at least an alkali-soluble acrylic copolymer having a molecular weight of between 7000 and 15,000, an acid value between 30 and 100, and a glass transition point of between −10° and 60° C., a lower alcohol solvent, water, and a coloring material, at a temperature between room temperature and about 60°, preferably between room temperature and about 50°.

5. The method as described in claim 4, wherein said alkali-soluble acrylic copolymer is provided by copolymerizing a number of polymers selected from a group comprising crylic esters, styrene, acrylic acid, maleic acid, methacrylic acid, or the like, having acidic groups such as carboxyl group in molecule, and dissolving it in water in the coexistence with alkaline substances.

6. The method as described in claim 4, wherein said lower alcohol solvent is selected from a group comprising ethanol, isopropyl alcohol, n-propyl alcohol, propylene glycol monomethyl ether, and a mixture thereof.

7. The method as described in claim 4, wherein said coloring material is selected from a group comprising pigments for ordinary alcohol-series, and water-series inks.

8. The method as described in claim 4, wherein the amount of said alkali-soluble acrylic copolymer in the watercolor ink composition is between 20 and 55 weigth percent.

9. The method as described in claim 4, wherein between 20 and 80 weight percent of said water is in a mixture of said water and said lower alcohol solvent.

10. The method as described in claim 4, wherein at least an additive selected from the group comprising dispersants, thickeners, wetting agents, high-boiling organic solvents, preservatives, rust preventives, is added to the watercolor ink compositions.
